(19) United States
(12) Patent Application Publication
(10) Pub. No.: US 2022/0398297 A1
(43) Pub. Date: Dec. 15, 2022

(54) SECURE PRINTING TO PRESERVE PROPRIETARY CONTENT

(71) Applicant: Hewlett-Packard Development Company, L.P., Spring, TX (US)

(72) Inventors: Craig Peter Sayers, Palo Alto, CA (US); Helen Balinsky, Bristol (GB)

(73) Assignee: Hewlett-Packard Development Company, L.P., Spring, TX (US)

(21) Appl. No.: 17/770,070

(22) PCT Filed: Oct. 31, 2019
(86) PCT No.: PCT/US2019/059166

§ 371 Date: Apr. 19, 2022

(51) Int. Cl. G06F 21/10; G06Q 30/00; G06F 21/60

(52) U.S. Cl. CPC G06F 21/10; G06Q 30/0185; G06F 21/608; G06Q 2220/00

(57) ABSTRACT

The present disclosure pertains to systems and methods of secure printing to preserve proprietary content. In some examples, a system may include utilizing a verifiable content summary with a lower resolution version of the content and a full-detail distinguishing excerpt of the content. In some examples, the system may provide a user with a verifiable content summary to facilitate authentication of a received physical content item.

### BACKGROUND

Artists, manufacturers, designers, and other vendors may create images and/or objects that can be printed using two-dimensional or three-dimensional printers. For example, a vendor may create a two-dimensional digital image file or a three-dimensional design file that can be electronically transmitted and shared. A customer may select an image or object created by a vendor and request that a manufacturer print and deliver the image or object. The manufacturer may print the image or object using a two-dimensional or three-dimensional printer.

### BRIEF DESCRIPTION OF THE DRAWINGS

Non-limiting and non-exhaustive examples of the disclosure are described, including various examples of the disclosure, with reference to the figures, in which:

FIG. 1 illustrates a block diagram of an example content authentication system.

FIG. 2A illustrates an example verifiable content summary with a hash stored in a blockchain ledger.

FIG. 2B illustrates an example of a digitally signed verifiable content summary.

FIG. 3 illustrates a block diagram of an example verifiable content summary.

FIG. 4 illustrates a specific example of a portion of a verifiable content summary.

FIG. 5 illustrates another specific example of a portion of a verifiable content summary.

FIG. 6 illustrates another specific example of a portion of a verifiable content summary.

FIG. 7 illustrates a block diagram of an example of a secure online shop of content items that include verifiable content summaries and full detail content items.

FIG. 8 illustrates a flowchart of an example method for creating a secure, verifiable content summary for a content item.

FIG. 9 illustrates a flowchart of an example method for verifying a vendor is providing requested content.

FIG. 10 illustrates a flowchart of an example method for generating and digitally signing a verifiable content summary.

### DETAILED DESCRIPTION

In modern product production, two entities may work together to create one item. For instance, a vendor (e.g., an owner of artwork) and a manufacturer may work together to provide a customer with customized artwork (e.g., a two-dimensional or three-dimensional artwork) with an agreement that the customer and/or the manufacturer will have limited rights to the artwork. For example, the customer may receive one manufactured/printed copy of the customized artwork (e.g., a physical object embodying the customized artwork), while the vendor retains ownership of the artwork. The vendor may create physical and/or digital artwork that can be manufactured (e.g., two-dimensionally or three-dimensionally printed or otherwise manufactured). The manufacturer may use a digital copy of the artwork or digital specifications of the artwork to make the item for delivery to the customer. The manufacturer may have temporary rights to implement the manufacturing process.

The vendor, in some instances, an artist, may trust the manufacturer and/or have agreements in place to prevent the manufacturer from disseminating, copying, or otherwise misusing the produced content item. The customer may want to verify that the manufacturer has accurately produced the content item created by the vendor for the customer. Since anyone with access to the full-detail digital content item may reproduce the object at will, the vendor may fear to share the full-detail digital content item with the customer or other untrusted entities. Thus, the vendor may fear to share the full-detail digital content item for verification purposes because the customer may use the artwork without compensating the vendor.

On the other hand, the customer may fear to compensate the vendor (or even place an initial order or proceed with a purchase) without having a way to authenticate that an ordered product matches the product that is ultimately received. The lack of trust between the vendor and the customer may make it difficult to impossible to complete a transaction. Being unable to verify a product may leave a customer open to receiving a fake or counterfeit product. However, providing the customer with a full-detail version of the content item leaves a vendor open to theft of his/her content.

The content authentication systems and methods described herein provide vendors and customers the ability to order and produce products with confidence. Vendors may create artwork or other protected content without fear that the customer (or other entity) may use or reproduce the content item without the vendor's permission and/or authorization. Customers may order a product with confidence that the received product matches the ordered product. Utilizing the content authentication system may increase trust between the parties. Additionally, the content authentication system may increase the ability to provide products to customers, particularly customized products.

In some examples, the content authentication system may generate a verifiable content summary. In some examples, a verifiable content summary may comprise a low-resolution version of the requested item and a distinguishing excerpt of the high-resolution version of the requested item locationally defined with respect to the content item. For instance, the verifiable content summary may explicitly include information identifying the location of the distinguishing excerpt relative to the content item. Alternatively, in some instances, the location of the distinguishing expert may be contextually inferred. In some examples, the verifiable content summary may be digitally signed by the vendor and/or a certifying party on behalf of the vendor that is trusted by the customer. In some examples, the system generates a hash of the verifiable content summary for retention in a blockchain ledger and/or as part of an immutable record/transaction (e.g., a publicly verifiable record or transaction).

In some examples, a content item comprises an object to be three-dimensionally printed or otherwise manufactured by a manufacturer. In some examples, the content item comprises an image to be two-dimensionally printed by the manufacturer. In some examples, the content item comprises an image to be printed on a three-dimensional object (e.g., as a texture or image on the object) by the manufacturer. In some examples, the content item may be a two-dimensional image for printing, text for printing, a pattern for printing, or a three-dimensional object to be printed via a 3D printer or otherwise 3D manufactured. In some examples, a system may facilitate or allow for customization of the printed image or object.

Many of the examples described herein refer to a customer, a vendor, and a manufacturer. However, it is appreciated that a customer may order a content item from a vendor who is also the manufacturer. Additional entities may also be involved. For example, a designer may have originally designed a printable item that is now being sold by a vendor for printing or recreation by a manufacturer and ultimate delivery to a customer or other user of the systems described herein. In such an example, the vendor may only have access to low-quality digital versions of the content item for display on, for example, a website. The designer of the item may want to protect his/her original work and prevent public dissemination of full-resolution copies of the digital content. The designer may trust the manufacturer with the content but may not trust a customer or the vendor with the content. In such instances, the designer may implement some of the actions described below as being taken by the vendor.

The examples of the disclosure may be further understood by reference to the drawings, wherein like parts are designated by like numerals throughout. It will be readily understood that the components of the disclosed examples, as generally described and illustrated in the figures herein, could be arranged and designed in a wide variety of different configurations. Thus, the following detailed description of the examples of the systems and methods of the disclosure is not intended to limit the scope of the disclosure, as claimed, but is merely representative of possible examples of the disclosure. In addition, the elements of a method do not necessarily need to be executed in any specific order, or even sequentially, nor need the elements to be executed only once, unless otherwise specified.

In some cases, well-known features, structures, or operations are not shown or described in detail. Furthermore, the described features, structures, or operations may be combined in any suitable manner in various examples. It will also be readily understood that the components of the examples as generally described and illustrated in the figures herein could be arranged and designed in a wide variety of different configurations.

Several aspects of the examples described may be implemented as software modules or components. As used herein, a software module or component may include any type of computer instruction or computer-executable code located within a memory device and/or transmitted as electronic signals over a system bus or wired or wireless network. A software module or component may, for instance, comprise physical or logical blocks of computer instructions, which may be organized as a routine, program, object, component, data structure, etc., that performs tasks or implements particular abstract data types.

In certain examples, a particular software module or component may comprise disparate instructions stored in different locations of a memory device, which together implement the described functionality of the module. Indeed, a module or component may comprise a single instruction or many instructions and may be distributed over several different code segments, among different programs, and across several memory devices. Some examples may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Examples may be provided as a computer program product, including a non-transitory computer and/or machine-readable medium having stored thereon instructions that may be used to program a computer (or another electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor-executable instructions.

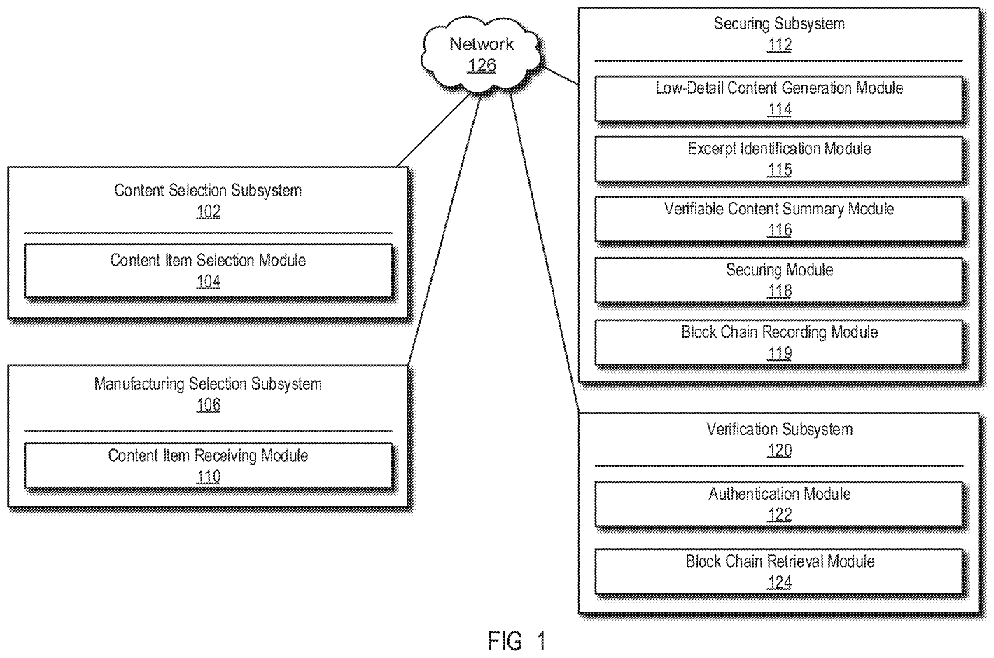

FIG. 1 illustrates a block diagram of various components of a content authentication system. The system may include a content selection subsystem 102, a manufacturing selection subsystem 106, a securing subsystem 112, and a verification subsystem 120 connected via a communication network 126. The content selection subsystem 102 may include a content item selection module 104 to facilitate the selection of a content item available from a vendor. For example, a customer may utilize the content item selection module 104 of the content selection subsystem 102 to view and select an electronic rendering of a content item. In some examples, the content selection subsystem 102 may further include a module to facilitate a customer selection of a manufacturer to create or reproduce a physical version of the selected content item.

A manufacturing selection subsystem 106 may include a content item receiving module 110 to receive a full-detail content item (e.g., a digital full-detail copy or version of the content item) corresponding to the customer-selected content item. A full-detail version of the content item is accessible to the manufacturer allowing the manufacturer to manufacture a physical version of the content item. For example, the vendor may provide the manufacturer a digital copy or version of the content item via the manufacturing selection subsystem 106 and/or the manufacturer may utilize the manufacturing selection subsystem 106 to retrieve the digital, full-detail content item. The manufacturer may then create or reproduce a physical version of the selected content item for delivery to the customer or another user. The full-detail version or copy of the digital content item is not accessible by the user (e.g., the customer) to prevent the user from disseminating, sharing, replicating, or otherwise using the digital, full-detail version of the content item in an impermissible manner.

The customer may use a verification subsystem 120 to verify that a received content item corresponds to the item requested from the vendor. As described herein, the customer may authenticate a verifiable content summary and then use the verifiable content summary to verify the received content item. As described below, a securing subsystem 112 may generate the verifiable content summary.

A low-detail content generation module 114 of the securing subsystem 112 may generate a low-detail, digital version of the content item. An excerpt identification module 115 of the securing subsystem 112 to generate or identify a distinguishing excerpt of the content item. The distinguishing excerpt may be locationally defined with respect to the full, low-detail version of the content item. A verifiable content summary module 116 of the securing subsystem 112 may generate a verifiable content summary that includes the low-detail version of the content item and the locationally defined distinguishing excerpt. A securing module 118 of the securing subsystem 112 may generate a hash of the verifiable content summary. A blockchain recording module 119 of the securing subsystem 112 may record the hash of the verifiable content summary on a blockchain ledger. In some examples, the securing module 118 of the securing subsystem 112 may digitally sign the verifiable content summary, and the blockchain may not be utilized.

Accordingly, as described herein, the low-detail content generation module of the securing subsystem 112 generates a low-detail version of the content item with a detail level less than that of a full-detail version. The excerpt identification module 115 of the securing subsystem 112 selects a distinguishing excerpt from the original resolution full-detail content item. The distinguishing excerpt of the content item may be chosen to distinguish similar content from the same vendor, similar products from the same manufacturer, or unauthorized versions from other vendors or produced by other manufacturers. As described herein, the full-detail version of the content item may refer to a digital version of the content item as originally created, produced, or generated by the vendor or other entity. In some examples, the full-detail version of the content item may refer to a digitized version of a physical content item created, produced, or generated by the vendor or other entity. For example, the full-detail version of a sculpture may be a three-dimensional design file defining the sculpture as originally created by the artist. Alternatively, the full-detail version of the sculpture may be a three-dimensional design file obtained by scanning a physical model of the sculpture originally created by the artist.

A low-detail version of the full-detail content item may, for example, resemble the full-detail version but lack some details and/or be represented as a low-resolution image rendered from the full-detail version. In some example, the detail or high-resolution qualities of the content item may set the content item apart from similar images or objects made by others. For example, a full-detail version of a painting of a sunset may include visible brushstrokes that distinguish the painting from other similar paintings of sunsets. As another example, a full-detail version of a sculpture may include intricate details. The low-detail version of the painting may, for example, omit the distinguishing brushstrokes. Similarly, the low-detail version of the sculpture may convey the general shape of the sculpture but omit the intricate details.

The customer or another user may utilize the verification subsystem 120 to verify that a received content item (e.g., a physical item) is authentic and corresponds to the content item ordered from the vendor. The verification subsystem 120 includes an authentication module 122 and a blockchain retrieval module 124. The blockchain retrieval module 124 may retrieve the hashed version of the verifiable content summary, and/or other information from a blockchain ledger. The customer or another user may use the information in the blockchain ledger to verify the authenticity of the verifiable content summary. The verification subsystem 120 may include an authentication module 122 to authenticate the digitally signed verifiable content summary or the secured hash of the verifiable content summary. The verification subsystem 120 may provide the authenticated verifiable content summary to the user in response to an authentication request to enable the user to determine if the received content item matches the ordered content item. The digital signature or hash of the verifiable content summary is validated to ensure the verifiable content summary is authentic, generated by the original content vendor, and/or as not been modified since.

The verification subsystem 120 may then render the verifiable content summary for display on an electronic display to facilitate a comparison of the received content item with the low-detail version of the content and a portion of the received content item with the locationally defined distinguishing excerpt of the full-detail version of the content item rendered on the electronic display. The user may compare the received content item to the low-detailed version of the verifiable content summary to verify the item as a whole. The user may further compare the distinguishing excerpt of the full-detail content item to the corresponding excerpt of the received item to ensure the details are authentic. Additionally, comparing the received item to the verifiable content summary with the locationally defined distinguishing excerpt of the full-detail content item enables the user to determine if the received content item matches the requested content item.

In various examples, the digital signature of a verifiable content summary, a hash of a verifiable content summary, and/or the digitally signed verifiable content summary itself may be included as a payload of a blockchain transaction. In some examples, a digitally signed verifiable content summary may be directly included as data in a blockchain transaction. In other examples, a computed hash of the verifiable content summary may be included as a payload of a blockchain transaction. In such examples, the verifiable content summary may reference a location (e.g., an address) where the blockchain transaction may be found.

The user may utilize the verification subsystem 120 to verify the received content item is the content item the user requested. The verification subsystem 120 may render the verifiable content summary for display on an electronic display. Utilizing the displayed verifiable content summary, the user may compare the received content item with the low-detail version of the content item on the electronic display. Comparing the displayed version with the received version allows the user to compare the content item as a whole. The user may further compare the received content item to the distinguishing excerpt of the full-detail version of the content item.

Comparing an excerpt of the received content item allows the user to compare in better detail a specific portion of the content item in high-detail. For example, a user may have ordered a 3D print of a stock animation tree. The user may compare the tree as a whole to the low-detail image. The user may further compare a leaf on the tree in full-detail to a leaf on the received animation tree. In some examples, the distinguishing excerpt 115 of the full-detail version of the content item is locationally defined with respect to the content item. For example, the leaf in the tree may be locationally defined to allow the user to know which leaf in the tree the user is comparing.

In some examples, a vendor may process a request for artwork—for instance, a child's name under a trademarked character. A manufacturer may utilize this content to produce a t-shirt with artwork from the vendor. Once produced, the customer may receive a customized t-shirt. The customer may send an authentication request to view the verifiable content summary on an electronic display, such as a laptop. The verification subsystem 120 may retrieve a hash of the verifiable content summary or other digital signature associated with the verifiable content summary. The verification subsystem 120 may authenticate the verifiable content summary itself.

As described herein, the verifiable content summary may include a low-detail version of the content item and a locationally defined, full-detail distinguishing excerpt of the content item. The customer may then compare the received content item, the t-shirt, to the low-detail version of the content item rendered on the laptop. The customer may further compare the t-shirt with the locationally defined distinguishing excerpt of the full-detail version of the content item rendered on the laptop. If the user is satisfied with the comparison, the user may be assured and/or confirm that the received item is the ordered item.

In some examples, the original content item is modified per customization instructions. In these examples, the retrieved content item at a first resolution comprises a modified original content item at the first resolution. For example, a customer may request a customized wallpaper. The wallpaper may feature a particular trademarked character, and a customer may further customize the wallpaper by selecting a particular scenery or monogram to accompany the trademarked character. The content authentication system 100 allows the user to review the artwork to determine if the received wallpaper is authentic. In some examples, the user may review the artwork to determine if the received content is a counterfeit. In other examples, the content authentication system 100 may allow the user to spot and remedy other issues with the received content item.

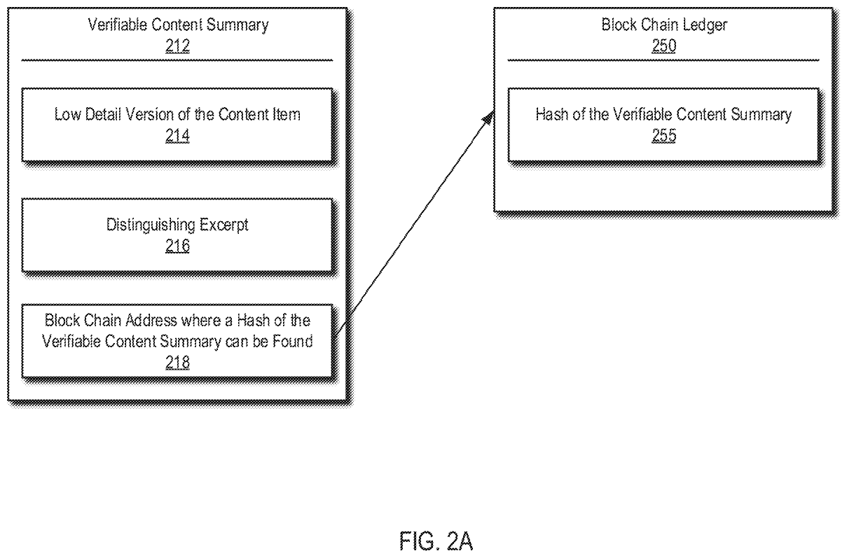

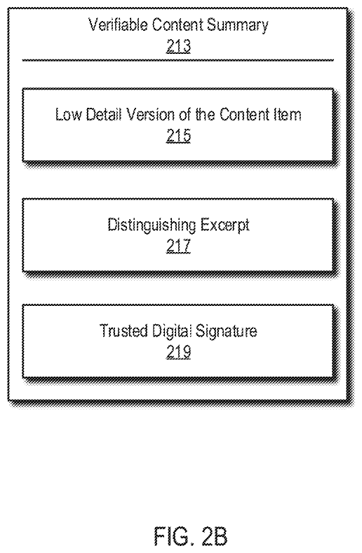

FIG. 2A illustrates a block diagram of an example of a verifiable content summary 212 that includes a low detail version of the content item 214, a distinguishing excerpt 216, and an address 218 of a blockchain where a hash of the verifiable content summary can be found. The verifiable content summary 212 may be based on a two-dimensional content item or a three-dimensional content item. For example, a golfer may request a customized hat from a vendor. The vendor may utilize a two-dimensional image to generate artwork for the hat. In some examples, the vendor may add a specific detail (overt or covert) to the artwork that can be used as the distinguishing excerpt 216. The vendor may send an image of the artwork to a manufacturer to produce the hat with the corresponding artwork.

The golfer may receive the hat and retrieve a verifiable content summary 212 to authenticate the artwork on the hat. The verifiable content summary 212 may include an address 218 where a hash of the verifiable content summary can be found. The golfer may use a verification subsystem to retrieve the hash of the verifiable content summary 255 (e.g., a secure hash) from a blockchain ledger 250. The verifiable content summary can use the secure hash 255 to verify the authenticity of the verifiable content summary. The golfer can then compare the artwork on the received hat with the low detail version of the content item 214. The distinguishing except 216 may be locationally defined and indicate the relative location of the aforementioned overt or covert specific detail. The specific detail may be small enough to require the golfer to use a magnifying glass. The golfer can confirm the authenticity of the received artwork on the hat by comparing received content time with the distinguishing excerpt.

FIG. 2B illustrates an alternative example of a verifiable content summary 213 that includes a low detail version of the content item 215 and a locationally defined distinguishing excerpt 217. However, the example verifiable content summary 213 is digitally signed with a trusted digital signature 219. The user (e.g., the golfer) can verify the authenticity of the verifiable content summary 213 based on the trusted digital signature instead of using a hashed version of the verifiable content summary stored in a blockchain ledger (as described in conjunction with FIG. 2A.

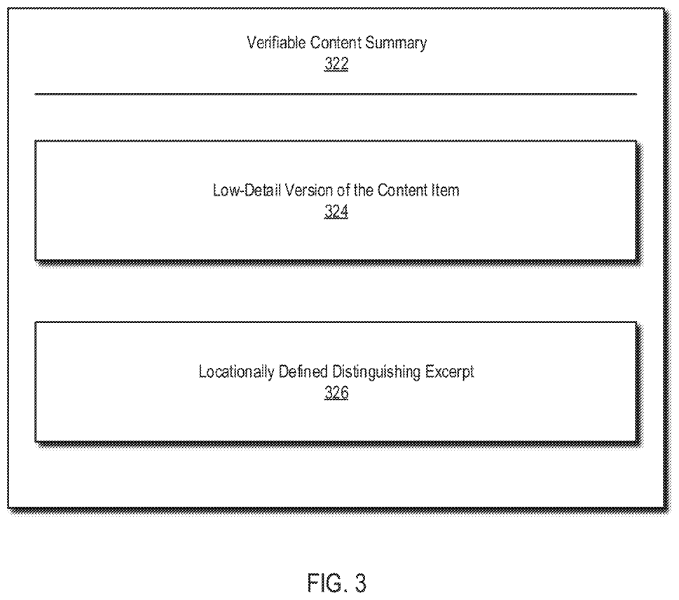

FIG. 3 illustrates a block diagram of an example verifiable content summary 322 that does not include a digital signature or an address to a blockchain location. Instead, A verification subsystem may itself be trusted and provide the verifiable content summary 322 directly to the customer. Alternatively, the verification subsystem may know where to find a hash of the verifiable content summary 322. In such examples, the verifiable content summary 322 allows a user to verify an ordered content item is the authentic version without viewing the full-detail digital content. The verifiable content summary 322 allows the user to view a low-detail version of the content item 324 in conjunction with a distinguishing excerpt of the full-detail version of the content item 326 locationally defined with respect to the content item. The combined view of the full low-detail version of the content item 324 with the distinguishing excerpt of the full-detail version of the content item 326 allows the user to authenticate the received content item with confidence.

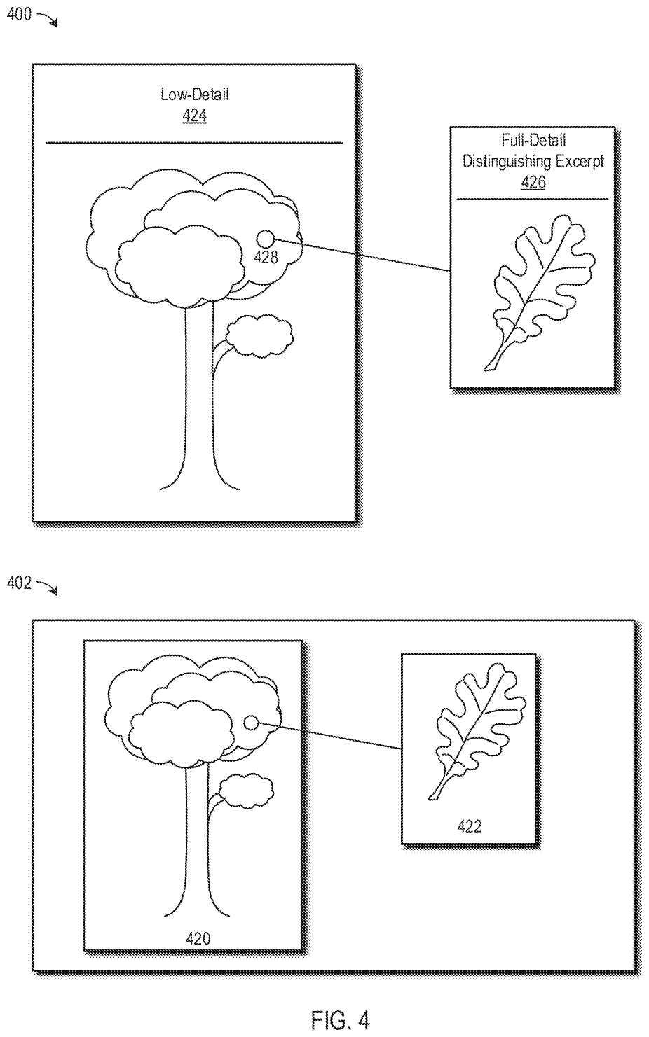

FIG. 4 illustrates a specific example of a portion of a verifiable content summary 400. The verifiable content summary 400 allows a user to verify an ordered content item without viewing the full-detail digital content. The verifiable content summary 400 allows the user to view a low-detail version of the content item 424 and a distinguishing excerpt of the full-detail version of the content item 426 locationally defined 428 with respect to the content item. The illustrated example demonstrates, utilizing verifiable content summary 402, how low-detail versions of each tree 420 and 424 may be similar in comparison while distinguishing excerpts of the full-detail versions of each leaf 422 and 426 may be different. As illustrated, the user may compare to determine the received content item is the requested content item as a whole and in detail without reviewing the full full-detail digital artwork.

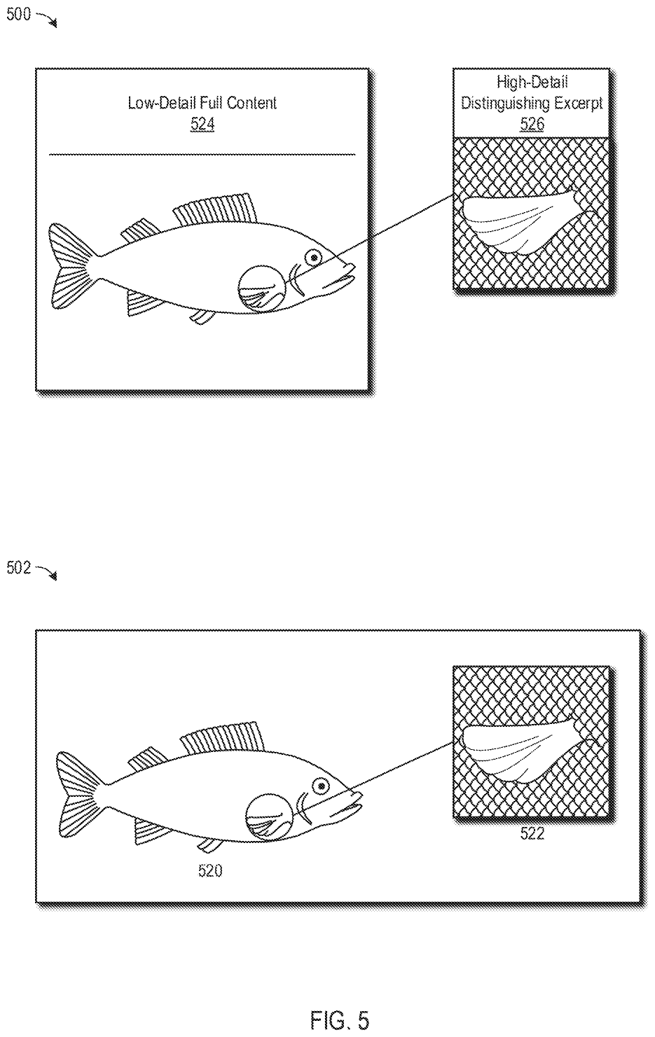

FIG. 5 illustrates another specific example of a portion of a verifiable content summary 500. This illustrated example demonstrates, utilizing verifiable content summary 502, how a low-detail version of each fish 520 and 524 are similar in comparison while a full-detail version of each fin 522 and 526 are different. As illustrated, the user may compare the received product to the verifiable content summary 500 to determine the received content item is the requested content item as a whole and in detail without reviewing the full-detail digital artwork.

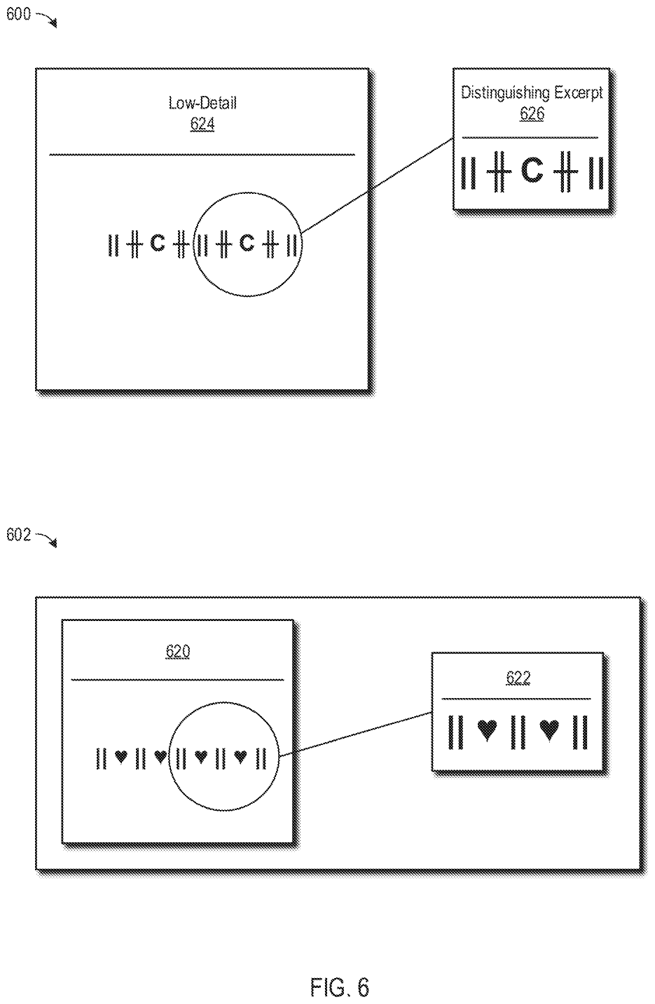

FIG. 6 illustrates another specific example of a portion of a verifiable content summary 600. Here, verifiable content summary 602 illustrates a low-detail version 620 wallpaper design and a low-detail version 624 customized version of the wallpaper. The low-detail versions of the wallpaper 620 and 624 may look similar. An excerpt from the full-detail customized version of the wallpaper design 622 may look different than an excerpt from a full-detail version of the wallpaper design 626. The user may utilize the received verifiable content summary 600, to compare the received product to the low-detail version 624 and the distinguishing excerpt of the full-detail version 626 to determine if the received item is the requested item.

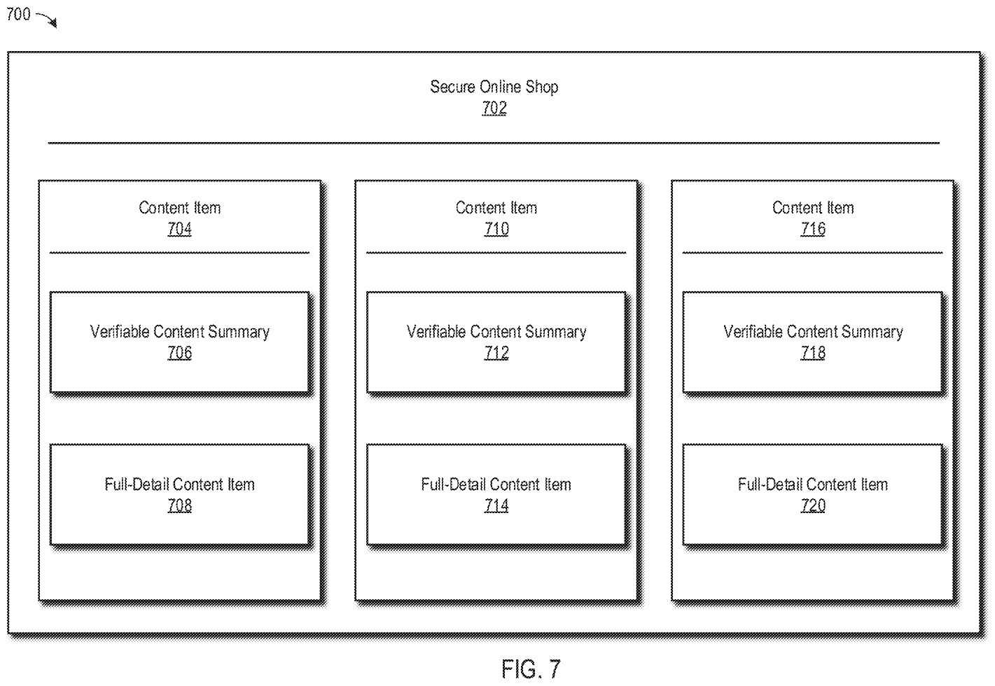

FIG. 7 illustrates a block diagram of an example of a portion of a content authentication system 700. Specifically, a secure online shop 702 of content items 704, 710, 716 is illustrated that include verifiable content summaries 706, 712, 718 and full detail content items 708, 714, 720. In some examples, the secure online shop 702 is a manufacturing selection subsystem. In some examples, verifiable content summary 706, 712, 718 may include a digital signature. A vendor may upload the full-detail content item 708 to the secure online shop 702. A merchant may utilize the full-detail content item 708 to produce an item for a customer. The secure online shop 702 may allow manufacturers to view the full-detail content item 708 without the user viewing the full-detail content item 708. The online shop 702 further allows the full-detail version of the full-detail content item 708 to be associated with the verifiable content summary 706, 712, 718.

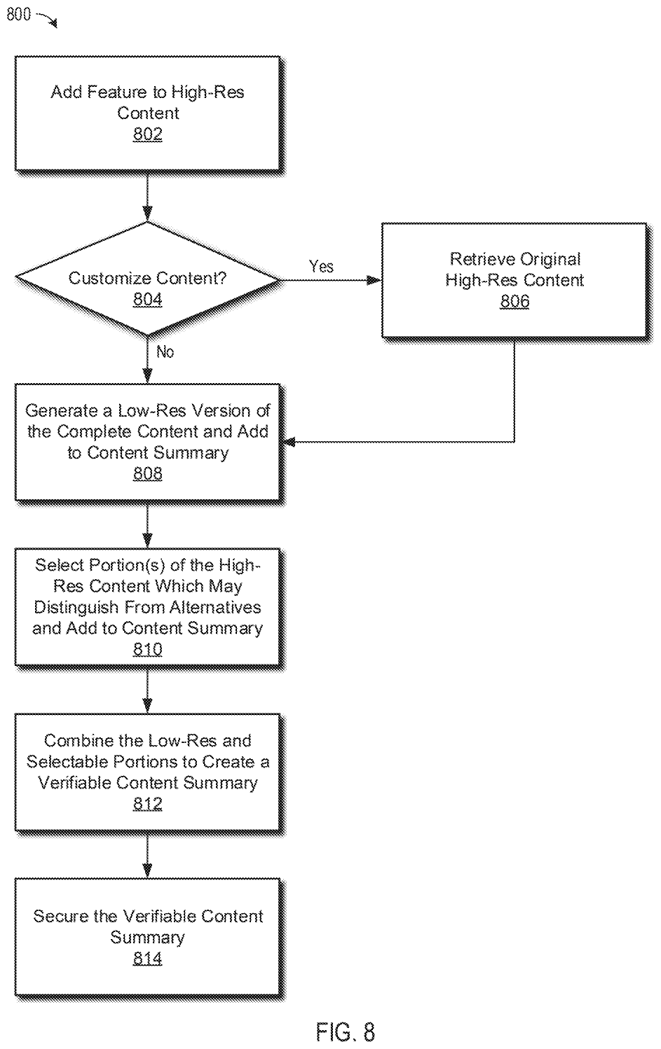

FIG. 8 illustrates a flowchart of an example method 800 for creating a secure, verifiable content summary for a content item. At 802, the original resolution full-detail content item is retrieved. At 804, it is determined if there is a request to customize the content item. If there is a request to customize the content item, the method proceeds to 806. At 806, a feature is added to the original resolution full-detail content item. In some examples, the feature is a feature requested by the customer. Once the feature is added, the method proceeds to 808. If there is not a request to customize the content item, the method proceeds to 808 following 804. At 808, a low-resolution rendering of the full-detail content item is generated. In some examples, the low-resolution version of the full-detail content item is added to the verifiable content summary.

At 810, an excerpt from the original resolution full-detail content item is selected to distinguish from other content items. In some examples, the selected distinguishing excerpt from the original resolution full-detail content item is added to the verifiable content summary. At 812, the low-resolution version and the distinguishing excerpt of the full-detail content item are combined to generate a verifiable content summary. At 814, the verifiable content summary is secured. For example, the verifiable content summary may be digitally signed by a trusted entity. The digital signature may be validated to confirm that the verifiable content summary is authentic and unchanged.

In other examples, the verifiable content summary may be secured by generating a hash of the verifiable content summary. The hash of the verifiable content summary may be entered as part of a blockchain ledger. In some examples, the verifiable content summary may include or otherwise be associated with an address of a location from which the secure hash of the verifiable content summary can be retrieved.

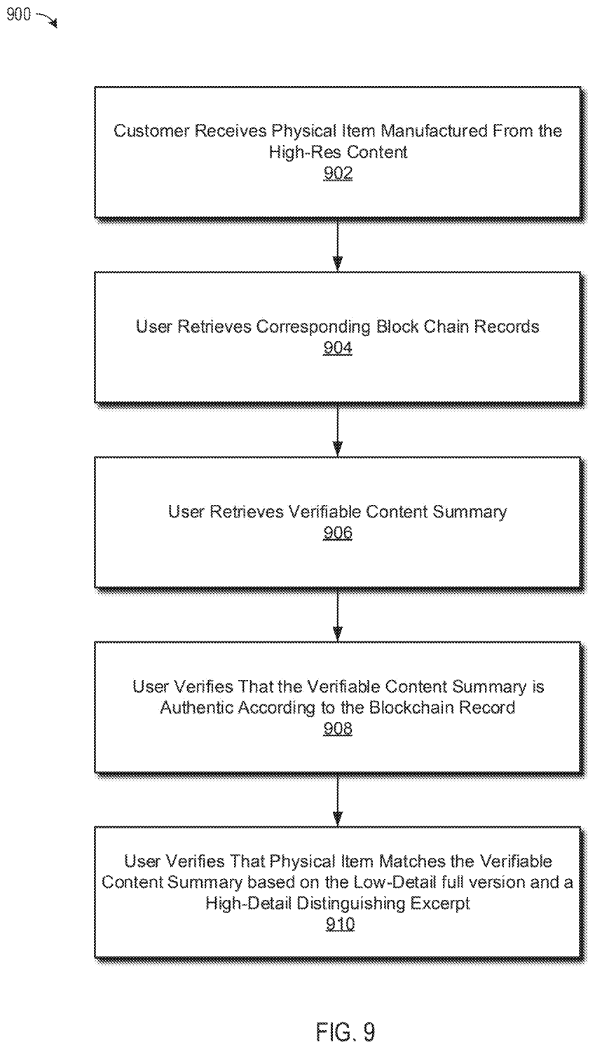

FIG. 9 illustrates a flowchart of an example method 900 for verifying a vendor is providing requested content. At 902, the user receives a requested physical item generated from an original resolution full-detail content item—for example, customized wallpaper. At 904, the customer receives signature records associated with the physical item. In some examples, signature records are a signature and/or identification of a person or entity. In some examples, signature records are records created by utilizing a blockchain method to secure the content item. In some examples, the blockchain records may include a hash of the verifiable content item that can be used to verify that the verifiable content item is authentic and unchanged. At 906, the user receives a verifiable content summary, including a low-resolution version of the full content item and a distinguishing excerpt of the original resolution full-detail version of the content item. At 908, the user may utilize the verifiable content summary and the secure hash of the verifiable content summary to ensure the verifiable content summary is authentic.

At 910, the user may verify the physical item matches the content provided by the verifiable content summary. In some examples, the user may examine the verifiable content summary before receiving the physical item to verify the artwork to be manufactured matches the requested artwork. For example, the user may check to see if customize wallpaper ordered by the user has the correct images, patterns, or customization. Once received, the user may verify that the received physical item matches the verifiable content summary by comparing the entire received content item with a low-detail full version of the content item and an identified portion of the received content item with the high-detail distinguishing excerpt.

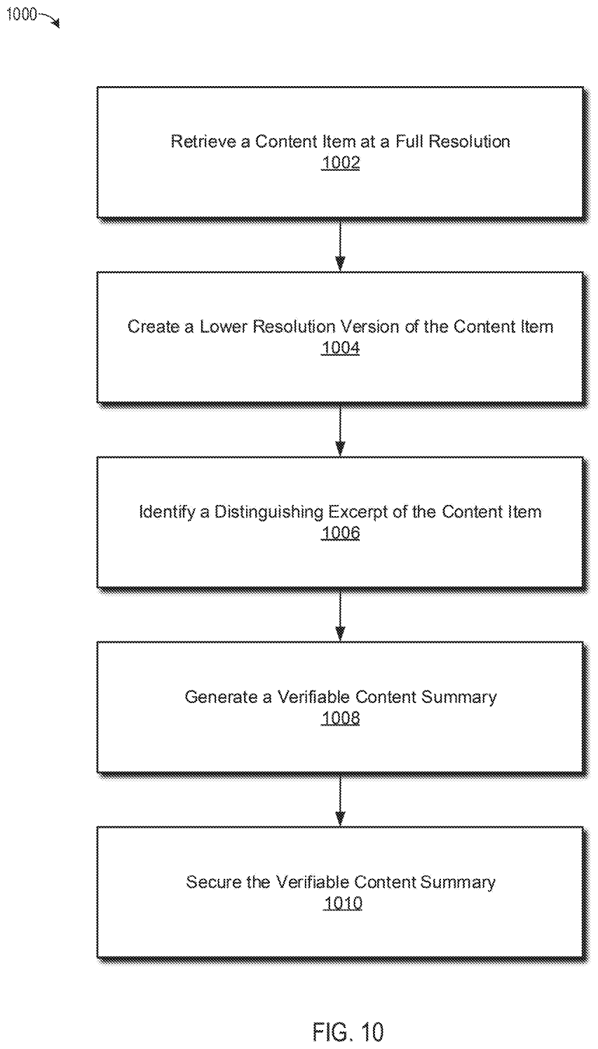

FIG. 10 illustrates a flowchart of an example method 1000 for generating and digitally signing a verifiable content summary. The method 100 may be implemented, for example, by a processor of a computing device or other computing system. The instructions, when executed by the processor, may cause the system to perform operations corresponding to those described below in conjunction with the method 1000. As illustrated, the system may retrieve, at 1002, a content item at a first, full resolution. The system may create, at 1004, a lower resolution version of the content item. The system may identify, at 1006, a distinguishing excerpt of the content item. In some examples, a user may identify the distinguishing excerpt, while in other examples the system may automatically detect or select a distinguishing excerpt. The distinguishing excerpt may be locationally defined with respect to the content item.

The system may generate, at 1008, a verifiable content summary that includes the lower resolution version of the content item and the distinguishing excerpt. In some examples, the verifiable content summary may further include information identifying the location of the distinguishing excerpt relative to the lower resolution version of the content item. The system may secure, at 1010, the generated verifiable content summary by, for example, digitally signing the verifiable content summary or writing a hash of the verifiable content summary to a blockchain ledger.

While specific examples and applications of the disclosure have been illustrated and described, it is to be understood that the disclosure is not limited to the precise configurations and components disclosed herein. Accordingly, many changes may be made to the details of the above-described examples without departing from the underlying principles of this disclosure. The scope of the present invention should, therefore, be determined only by the following claims.

What is claimed:

1. A non-transitory computer-readable medium with instructions stored thereon that, when implemented by a processor, cause the processor to perform operations for generating a verifiable content summary for secure content authentication, the operations comprising:
retrieving a content item at a first resolution;
creating a version of the content item at a second resolution that is lower than the first resolution;
identifying a distinguishing excerpt of the content item at the first resolution;
generating a verifiable content summary that includes:
the lower resolution version of the content item, and
the distinguishing excerpt of the content item at the first, higher resolution locationally defined with respect to the content item; and
securing the generated verifiable content summary with authentication information.

2. The non-transitory computer-readable medium of claim 1, wherein securing the generated verifiable content summary with authentication information comprises recording a hash of the verifiable content summary in a blockchain ledger, such that the recorded hash comprises the authentication information.

3. The non-transitory computer-readable medium of claim 1, wherein securing the generated verifiable content summary comprises digitally signing the verifiable content summary with a digital signature, such that the digital signature comprises the authentication information.

4. The non-transitory computer-readable medium of claim 1, wherein the verifiable content summary comprises explicit location information indicating a location of the distinguishing excerpt with respect to the content item.

5. The non-transitory computer-readable medium of claim 1, wherein retrieving a content item at the first resolution comprises:
retrieving an original content item at the first resolution; and
modifying the original content item per customization instructions, such that the retrieved content item at the first resolution comprises a modified original content item at the first resolution.

6. The non-transitory computer-readable medium of claim 1, wherein the content item comprises at least one of: a two-dimensional image for printing, text for printing, a pattern for printing, and a three-dimensional object to be printed via a 3D printer.

7. The non-transitory computer-readable medium of claim 6, further comprising:
providing the verifiable content summary to a user in response to an authentication request;
authenticating the provided verifiable content summary using the authentication information; and
rendering the verifiable content summary for display on an electronic display to enable the user to compare a user-received content item with the lower resolution version of the content item and a portion of the user-received content item identified by the location information with the distinguishing excerpt of the content item.

8. A method comprising:
transmitting a request for a verifiable content summary to facilitate authentication of a physical content item received by a user;
receiving the verifiable content summary, the verifiable content summary comprising:
a relatively low-resolution version of the content item, and
a distinguishing excerpt of the content item locationally defined with respect to the content item;
authenticating the verifiable content item; and
rendering the verifiable content summary for display on an electronic display to enable comparison, by the user, of the verifiable content summary and the physical content item.

9. The method of claim 8, wherein the distinguishing excerpt of the content item comprises a portion of the content item at a higher resolution.

10. A content authentication system, comprising:
a processor;
a content selection subsystem to receive a user selection of a content item from a vendor, wherein a full-detail version of the content item is not accessible by the user;
a manufacturing selection subsystem to receive a user selection of a manufacturer to manufacture the content item, wherein the full-detail version of the content item is made accessible to the manufacturer to facilitate manufacturing of the content item;
a securing subsystem to generate a verifiable content summary of the content item, the securing subsystem to:
create a low-detail version of the content item at a detail level less than that of the full-detail version,
generate a verifiable content summary of the content item that includes:
the low-detail version of the content item, and
a distinguishing excerpt of the full-detail version of the content item locationally defined with respect to the low-detail version of the content item, and
generate authentication information to facilitate authentication of the generated verifiable content summary; and
a verification subsystem to provide the verifiable content summary to the user in response to an authentication request to enable the user to:
authenticate the verifiable content summary using the authentication information;
render the verifiable content summary for display on an electronic display,
compare a received content item with the low-detail version of the content item rendered on the electronic display, and
compare a portion of the received content item with the locationally defined distinguishing excerpt of the full-detail version of the content item rendered on the electronic display.

11. The system of claim 10, wherein the securing subsystem is to generate the authentication information by storing a hash of the verifiable content summary in a blockchain ledger.

12. The system of claim 10, wherein the securing subsystem is to generate the authentication information by digitally signing the verifiable content summary.

13. The system of claim 10, wherein the content item comprises an object to be three-dimensionally manufactured by the manufacturer.

14. The system of claim 10, wherein the content item comprises an image to be two-dimensionally printed by the manufacturer.

15. The system of claim 10, wherein the content item comprises an image to be two-dimensionally printed on a three-dimensional object by the manufacturer.
